(19) United States
(12) Patent Application Publication
(10) Pub. No.: US 2025/0242534 A1
(43) Pub. Date: Jul. 31, 2025

(54) BARREL WITH A CORROSIVE RESISTANT MATERIAL AND METHOD OF FORMING

(71) Applicant: Xaloy, LLC, Austintown, OH (US)

(72) Inventors: Brad Lee QUEAR, Bessemer, PA (US); Cheryl Ann SAYER, Lowell, MA (US); Lance Richard TULLIS, Austintown, OH (US); Brian Louis LEPORE, Austintown, OH (US)

(73) Assignee: Xaloy, LLC, Austintown, OH (US)

(21) Appl. No.: 19/032,899

(22) Filed: Jan. 21, 2025

Related U.S. Application Data
(60) Provisional application No. 63/625,087, filed on Jan. 25, 2024.

(51) Int. Cl. B29C 48/68; B29C 45/62

(52) U.S. Cl. CPC B29C 48/6803; B29C 48/6801; B29C 45/62

(57) ABSTRACT

A barrel with a corrosive resistant material having a first end and a second end spaced apart from one another. The barrel also has an outer surface and an inner surface spaced apart from one another. The outer surface and the inner surface extend between the first end and the second end. The barrel includes at least one notch extending from the outer surface to the inner surface. The at least one notch is filled with the corrosive resistant material from a base end of the notch to the outer surface. The barrel further includes a passage extending through the corrosive resistant material inside of the at least one notch.

### REFERENCE TO RELATED APPLICATIONS

This application claims the benefit of U.S. Provisional Application Ser. No. 63/625,087, filed on Jan. 25, 2024; the disclosure of which is incorporated herein by reference.

### TECHNICAL FIELD

This disclosure is directed to an extrusion or injection molding barrel. More specifically, the disclosure is directed to an extrusion or injection molding barrel for processing corrosive materials such as fluoropolymers or thermoplastic polymers and other materials which are highly corrosive to steel.

### BACKGROUND ART

Extrusion and injection molding are two widely used manufacturing processes in the production of plastic and other materials. The equipment used in the extrusion and injection molding processes are commonly made of various metals. A number of the materials used in the extrusion and injection molding manufacturing processes are highly corrosive to steel, such as fluoropolymers, Poly Lactic Acid, flame retardants, halogenated polymers, hygroscopic polymers, thermoset polymers, corrosive fillers, pigments: (i.e., cadium based), stabilizers, processing aids or other materials which are highly corrosive to steel.

These corrosive materials are melt processed using screws and barrels. However, these corrosive materials attack any steel on the manufacturing equipment in areas where they are in contact with the steel. These corrosive materials also attack any steel at the discharge end where a gas or vapor is released or given off. Therefore, areas of the manufacturing equipment that are in direct contact with the corrosive material or are exposed to the gases from the corrosive material need to be protected, such as the discharge ends and passages for device such as a pressure transducer.

Currently, corrosive resistant barrels are produced by two standard methods. The first method uses a solid corrosive resistant material, which is then machined into the necessary size and shape. The solid corrosive resistant material is typically high nickel content with low hardness such as Inconel. Corrosive resistant material is costly and the lead time for receiving a barrel made entirely of the corrosive resistant material is long.

The second method uses a rod stock or a tube of a corrosion resistant material which is machined with a removal process to be formed to a geometry that can be inserting or butt welded into the backing steel of the barrel in the areas of corrosion. In this method, a large piece of solid corrosive resistant material, such as Inconel, is used to cover the discharge end and extends to the pressure transducer, sometimes multiple are used along the length. The large piece, however, is inefficient as a large portion of the expensive material is removed and scrapped. These pieces of solid corrosive resistant material are sold and purchased in standard sizes, and the user may be required to purchase a size much larger than required due to availability. The pieces of solid corrosive resistant material are susceptible to cracking and leaking when the solid corrosive resistant material is welded to the base metal in the areas of thin cross-sections.

These conventional processes have a few problems, such as the outer diameter of the solid corrosive resistant material in the thin cross-section needing to closely match the inner diameter of the backing steel to ensure it is supported under the internal pressure during use of the corrosive resistant barrel. Additionally, the flat at the base of the solid corrosive resistant barrel thin cross-section must bottom out on the shoulder of the counterbore of the backing steel to ensure sealing. The weld locations on the barrel often cause issues with poor weld in finished product. Lastly, welding near the inlay causes issue with cracking.

### SUMMARY OF THE INVENTION

A barrel with a corrosive resistant material having a first end and a second end spaced apart from one another. The barrel also has an outer surface and an inner surface spaced apart from one another. The outer surface and the inner surface extend between the first end and the second end. The barrel includes at least one notch extending from the outer surface to the inner surface. The at least one notch is filled with the corrosive resistant material from a base end of the notch to the outer surface. The barrel further includes a passage extending through the corrosive resistant material inside of the at least one notch.

In one aspect, an exemplary embodiment of the present disclosure may provide a barrel with a corrosive resistant material with a first end and a second end spaced a distance apart from the first end and an outer surface and an inner surface spaced a distance apart from the outer surface. The outer surface and the inner surface extend between the first end and the second end. The barrel also includes at least one notch extending from the outer surface to the inner surface, where the at least one notch is filled with the corrosion resistant material from a base end of the notch and the outer surface. The barrel further includes a passage extending through of the corrosion resistant material inside of the at least one notch.

In another aspect, an exemplary embodiment of the present disclosure may provide a flange adjacent to at least one end of the barrel. In another aspect, an exemplary embodiment of the present disclosure may provide a discharge end adjacent to an end of the barrel. In another aspect, an exemplary embodiment of the present disclosure may provide where the discharge end and the flange each include an outer layer being made of the corrosion resistant material. In another aspect, an exemplary embodiment of the present disclosure may provide where the discharge end and the flange are made entirely of a corrosive resistant material. In another aspect, an exemplary embodiment of the present disclosure may provide where the corrosive resistant material of each outer layer is made of a high-velocity oxygen fuel coating. In another aspect, an exemplary embodiment of the present disclosure may provide a corrosion resistant inlay covering the inner surface. In another aspect, an exemplary embodiment of the present disclosure may provide where the corrosion resistant inlay defines a borehole extending from the first end to the second end of the barrel. In another aspect, an exemplary embodiment of the present disclosure may provide where the corrosive resistant material used to fill the at least one notch is corrosive resistant wire. In another aspect, an exemplary embodiment of the present disclosure may provide where the corrosive resistant material used to fill the at least one notch is corrosive resistant powder.

In another aspect, and exemplary embodiment of the present disclosure may provide a method of forming a barrel with a corrosive resistant material. The method includes providing an unfinished barrel, forming at least one notch into the unfinished barrel by cutting and removing a portion of the unfinished barrel, filing each of the at least one notch with a corrosive resistant material from an end of the at least one notch to an outer surface of the unfinished barrel, and forming a borehole into unfinished barrel until the end of the at least one notch is aligned with an inner surface of the unfinished barrel.

In another aspect, an exemplary embodiment of the present disclosure may provide where filing each of the at least one notch with the corrosive resistant material includes securing the corrosive resistant material to the end of the at least one notch, where the corrosive resistant material is a corrosive resistant wire, and simultaneously engaging and securing the corrosive resistant wire to itself until the corrosive resistant wire is aligned with the outer surface of the unfinished barrel. In another aspect, an exemplary embodiment of the present disclosure may provide the method further including securing a corrosive resistant inlay to the inner surface of the unfinished barrel. In another aspect, an exemplary embodiment of the present disclosure may provide the method further including forming at least one passage into the corrosive resistant material inside of the at least one notch and inserting a device into the at least one passage. In another aspect, an exemplary embodiment of the present disclosure may provide the method further including applying a corrosive resistant coating to the outer surface of the unfinished barrel. In another aspect, an exemplary embodiment of the present disclosure may provide where the corrosive resistant coating is a high-velocity oxygen fuel (HVOF) coating or a high-velocity air fuel (HVAF) coating. In another aspect, an exemplary embodiment of the present disclosure may provide the method further including engaging a flange with at least one end of the unfinished barrel. In another aspect, an exemplary embodiment of the present disclosure may provide the method further including engaging a discharge end with an end of the unfinished barrel. In another aspect, an exemplary embodiment of the present disclosure may provide the before engaging a discharge end with a first end of the unfinished barrel and engaging a flange with a second end of the unfinished barrel the method includes applying an outer layer to the discharge end, wherein the outer layer is made of the corrosive resistant material and applying an outer layer to the flange, wherein the outer layer is made of the corrosive resistant material. In another aspect, an exemplary embodiment of the present disclosure may provide where applying the outer layers to the discharge end and the flange includes building the outer layer with corrosive resistant material via welding. In another aspect, an exemplary embodiment of the present disclosure may provide where applying the outer layers to the discharge end and the flange includes spraying the discharge end and the flange with the corrosive resistant material. In another aspect, an exemplary embodiment of the present disclosure may provide the method further including defining a length along the unfinished barrel, determining a desired location along the length of the unfinished barrel, forming the at least one notch at the desired location, forming at least one passage into the corrosive resistant material inside of the at least one notch, and inserting a device into the at least one passage.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a front, left, top perspective view of a barrel in accordance with the present disclosure.

FIG. 2 (FIG. 2) is an enlarged front, left, top perspective view of the highlighted region shown in FIG. 1.

FIG. 3 (FIG. 3) is a cross-section view of a portion of the barrel taken along line 3-3 of FIG. 2.

FIG. 4 (FIG. 4) is a front, left, top perspective view of an unfinished barrel.

FIG. 5 (FIG. 5) is a cross-section view of the unfinished barrel taken along line 5-5 of FIG. 4.

FIG. 6 (FIG. 6) is a front, left, top perspective view of the unfinished barrel with a notch defined therein.

FIG. 7 (FIG. 7) is a cross-section view of the unfinished barrel as shown in FIG. 6 taken along line 7-7 of FIG. 6.

FIG. 8A (FIG. 8A) is an operational view of a corrosive resistant material wire being installed onto the notch of the unfinished barrel.

FIG. 8B (FIG. 8B) is an operational view of the corrosive resistant material wire installed onto the notch of the unfinished barrel and being secured by a laser welder.

FIG. 8C (FIG. 8C) is a front, left, top perspective view of the unfinished barrel with the corrosive resistant material wire installed.

FIG. 9 (FIG. 9) is a cross-section view of the unfinished barrel with the corrosive resistant material wire installed taken along line 9-9 of FIG. 8C.

FIG. 10A (FIG. 10A) is an operational view the unfinished barrel with the corrosive resistant material wire installed and being bored with an inner shaft to remove corrosive material.

FIG. 10B (FIG. 10B) is a front, left, top perspective view of a partially finished barrel.

FIG. 11 (FIG. 11) is a cross-section view of the partially finished barrel taken along line 11-11 of FIG. 10B.

FIG. 12 (FIG. 12) is a front, left, top perspective view of the partially finished barrel with a plurality of through holes extending through the corrosive resistant material wire and a corrosive resistant inlay along an inner diameter of the partially finished barrel.

FIG. 13 (FIG. 13) is a cross-section view of the partially finished barrel with the plurality of through holes taken along line 13-13 of FIG. 12.

FIG. 14 (FIG. 14) is a front, left, top perspective view of a second embodiment of a barrel in accordance with the present disclosure.

FIG. 15 (FIG. 15) is a flow chart depicting a method of forming the barrel.

Similar numbers refer to similar parts throughout the drawings.

### DETAILED DESCRIPTION

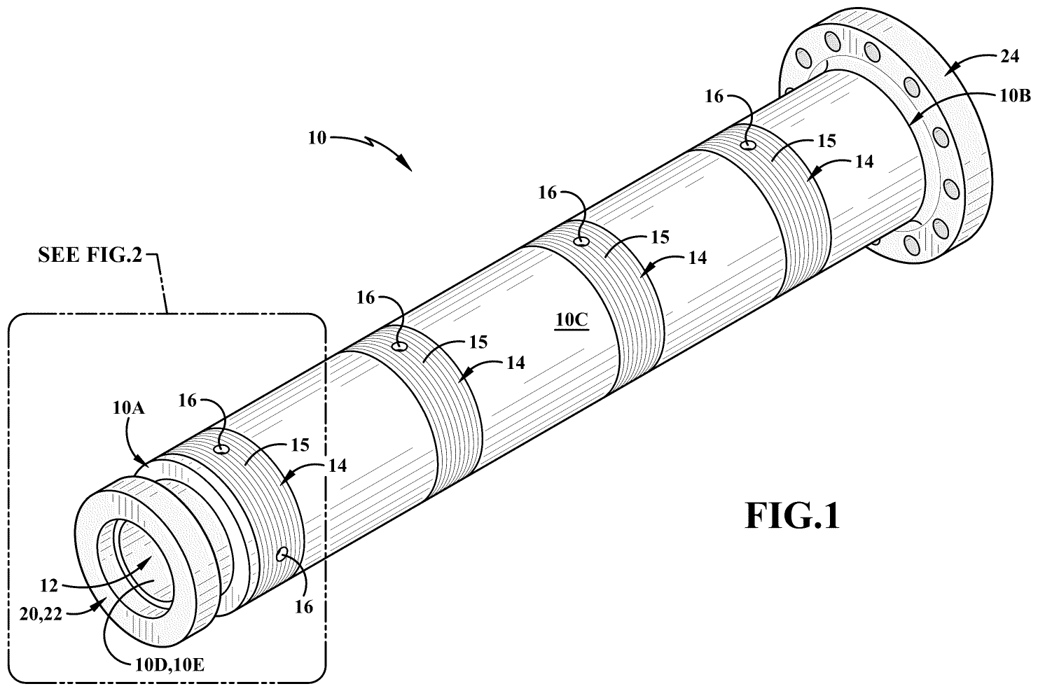

FIGS. 1-3 show a barrel 10 which may be used for extrusion or injection molding manufacturing processes. During these manufacturing processes, the barrel 10 is subject to corrosive materials, such as fluoropolymers or thermoplastic polymers and other materials which are highly corrosive to steel that corrodes steel or other metals that barrels are generally made of. Therefore, it is essential that areas of the barrel 10 are made of a corrosion resistant material.

Barrel 10 is made of at least two separate materials. The first material is steel or another similar metal. The second, illustrated herein in grayscale, is the corrosion resistant material. The greyscale is shown for diagrammatical purposes to distinguish the separate materials.

In FIG. 1, barrel 10 generally includes a first end 10A and a second end 10B opposite one another and defining a length of barrel 10, and a longitudinal direction extending from the first end 10A to the second end 10B. Barrel 10 further includes an outer surface 10C and an inner surface 10D opposite one another. It will be understood that inner surface 10D is covered in a corrosion resistant inlay 10E. It will be understood that the corrosion resistant inlay 10E may be in the form of a liner. It will also be understood that the corrosive resistant inlay 10E may be centrifugally case. It will further be understood that the corrosive resistant inlay 10E may be a high-velocity oxygen fuel (HVOF) spray coating or a high-velocity air fuel (HVAF) coating. It will also be understood that the corrosive resistant inlay 10E may be painted or wiped on like a ceramic.

Barrel 10 defines a borehole 12 extending through barrel 10 in the longitudinal direction from first end 10A to second end 10B. Borehole 12 is further defined by inner surface 10D of barrel 10. Borehole 12 is further defined by the corrosion resistant inlay 10E of barrel 10.

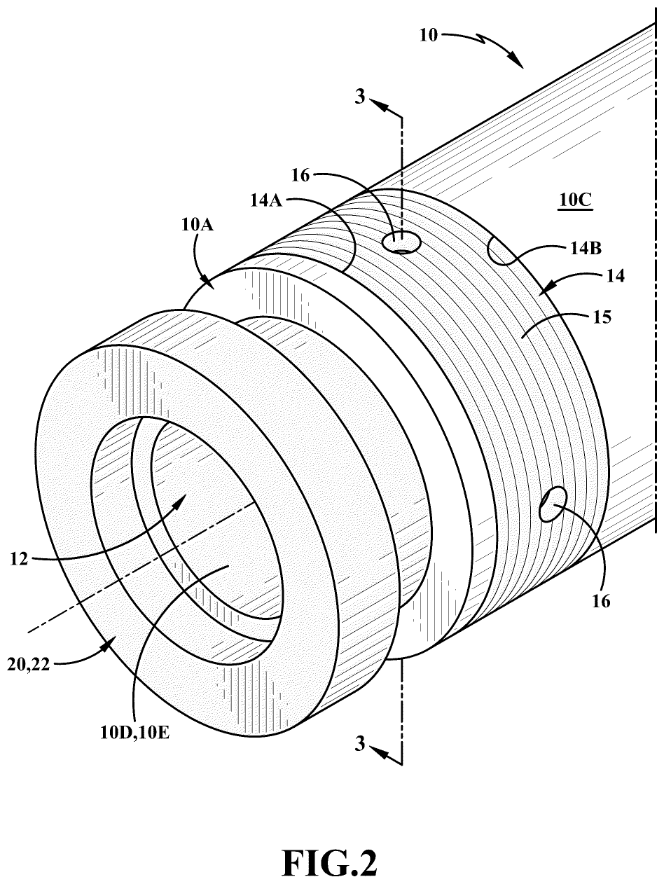

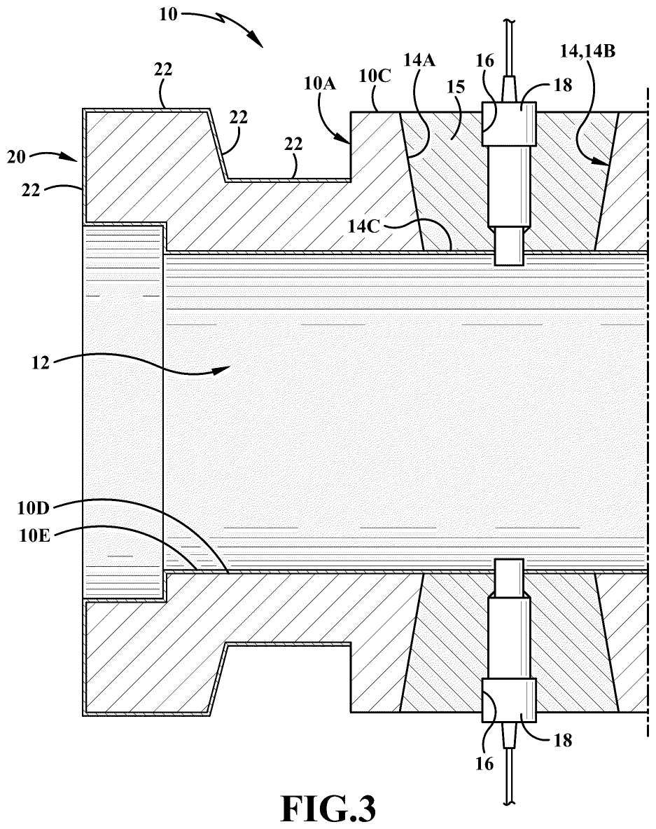

Referring now to FIGS. 2-3, barrel 10 also includes at least one filled notch 14 which is filled with the corrosion resistant material from the outer surface 10C to the inner surface 10D. Particularly, the at least one filled notch 14 includes a first side 14A and a second side 14B opposite one another. The at least one filled notch 14 further includes an end or base surface 14C defining the radially innermost point of the at least one filled notch 14.

Referring now to FIGS. 1-3, barrel 10 further defines a plurality of passages 16 in a corrosive resistant material 15 which is located in the at least one filled notch 14. The plurality of passages 16 extends from outer surface 10C to inner surface 10D. Each of the plurality of passages 16 are configured to receive a device 18 (FIG. 3), such as a pressure transducer, injection port, or vent port.

Referring now to FIGS. 2 and 3, barrel 10 includes a discharge end 20 located adjacent to the first end 10A of the barrel 10. Although not pictured herein, it will be understood that the discharge end 20 is adapted to allow for a fluid received within the barrel 10 to be moved to another stage in the extrusion or injection molding manufacturing processes. It will also be understood that in alternative embodiments, barrel 10 may include an end which is different from discharge end 20.

Referring to FIG. 3, discharge end 20 includes an outer layer 22 which circumvents an outer surface of the discharge end. Outer layer 22 is made of the corrosion resistant material. In one specific embodiment, the outer layer 22 is welded and built onto the discharge end 20. In another specific embodiment, the outer layer 22 is made of a high-velocity oxygen fuel (HVOF) coating or a high-velocity air fuel (HVAF) coating. It will be understood that the outer layer 22 is made of a ceramic that is painted or wiped on. In yet another specific embodiment, the discharge end 20 is a separate component from the remainder of the barrel 10, and the discharge end 20 is made entirely of corrosion resistant material and is secured to the barrel 10 using a manufacturing technique such as welding.

Barrel 10 further includes a flange 24 located adjacent to the second end 10B of the barrel 10 (see FIG. 1). Although not pictured herein, it will be understood that the flange 24 is adapted to engage another part of the extrusion or injection molding manufacturing processes such as a feed or a hopper. It will also be understood that in alternative embodiments, barrel 10 may include an end which is different from flange 24.

It will be understood that in alternative embodiments, barrel 10 may not include the discharge end 20 and include the flange 24 located adjacent to the first end 10A and the second end 10B of the barrel 10.

Although not pictured herein, it will be understood that flange 24 is similar to discharge end 20 and comprises an outer layer (not shown) which circumvents an outer surface (not shown) of the flange 24. The outer layer is similar to outer layer 22 and is made of the corrosion resistant material 32. In one specific embodiment, the outer layer is welded and built onto the flange 24. In another specific embodiment, the outer layer is made of a high-velocity oxygen fuel (HVOF) coating or a high-velocity air fuel (HVAF) coating. It will be understood that the outer layer 22 is made of a ceramic that is painted or wiped on. In yet another specific embodiment, the flange 24 is a separate component from the remainder of the barrel 10, and the flange 24 is made entirely of corrosion resistant material and is secured to the barrel 10 using a manufacturing technique such as welding.

It will be understood that in alternative embodiment, one or both of the discharge end 20 and flange 24 may not include the outer layer which is made of the corrosive resistant material 32.

In the present disclosure, barrel 10 is formed so that any corrosive material that is received within the borehole 12 engages only with the corrosive resistant inlay 10E, the at least filled notch 14 (where the filled notch 14 is filled with a corrosive resistant material), the device 18, the outer layer 22 of the discharge end 20 (where the outer layer 22 is made of the corrosion resistant material), and the outer layer (not shown) of the flange 24 (where the outer layer is made of the corrosion resistant material). In other words, the barrel 10 is sealed along certain portions such that any corrosive material that comes into contact with these portions of the barrel 10 is only in contact with corrosive resistant material provided with of barrel 10.

Having now described barrel 10, a process of producing barrel 10 will be discussed herein.

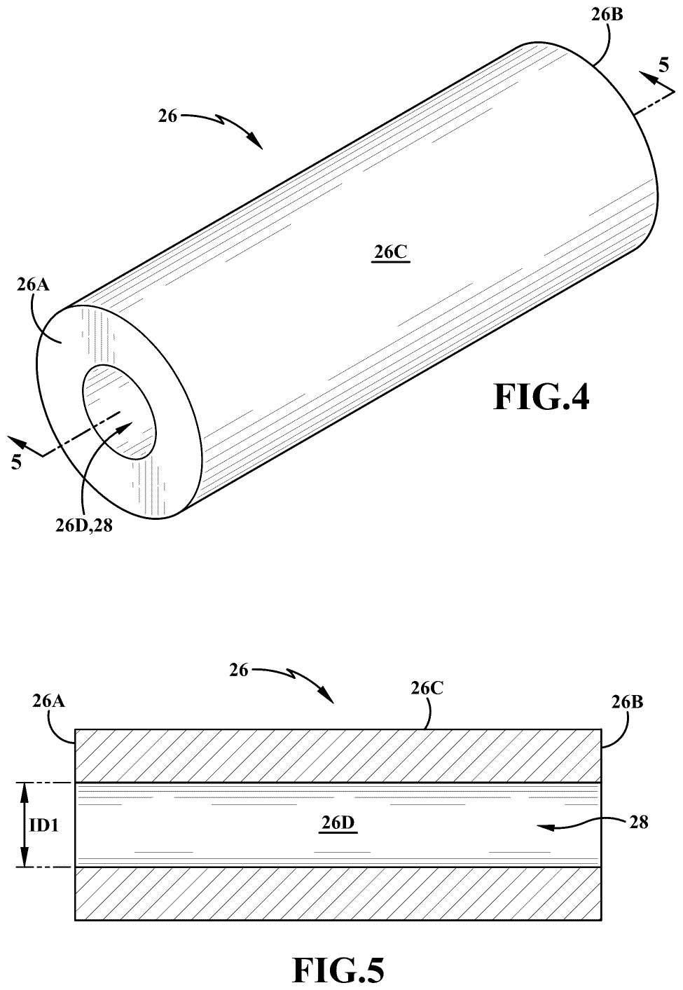

Referring now to FIGS. 4-5, there is shown an unfinished barrel 26. Unfinished barrel 26 generally includes a first end 26A and a second end 26B opposite one another and defining a length of unfinished barrel 26, and a longitudinal direction extending from the first end 26A to the second end 26B. Unfinished barrel 26 further includes an outer surface 26C and an inner surface 26D opposite one another. Unfinished barrel 26 defines a passageway 28 extending through unfinished barrel 26 from first end 26A to second end 26B. Passageway 28 is further defined by inner surface 26D of unfinished barrel 26. The passageway 28 also has an inner diameter “ID1” that is defined by the inner surface 26D of the unfinished barrel 26.

It will be understood that in alternative embodiments, unfinished barrel 26 may be a rod and not include the inner surface 26D, the passageway 28, or the inner diameter “ID1”. It will be understood that in alternative embodiments, unfinished barrel 26 may be a tube.

In one specific embodiment, unfinished barrel 26 is made of steel or other similar metals that are commonly used in extrusion or injection molding barrel of an extrusion or injection molding system.

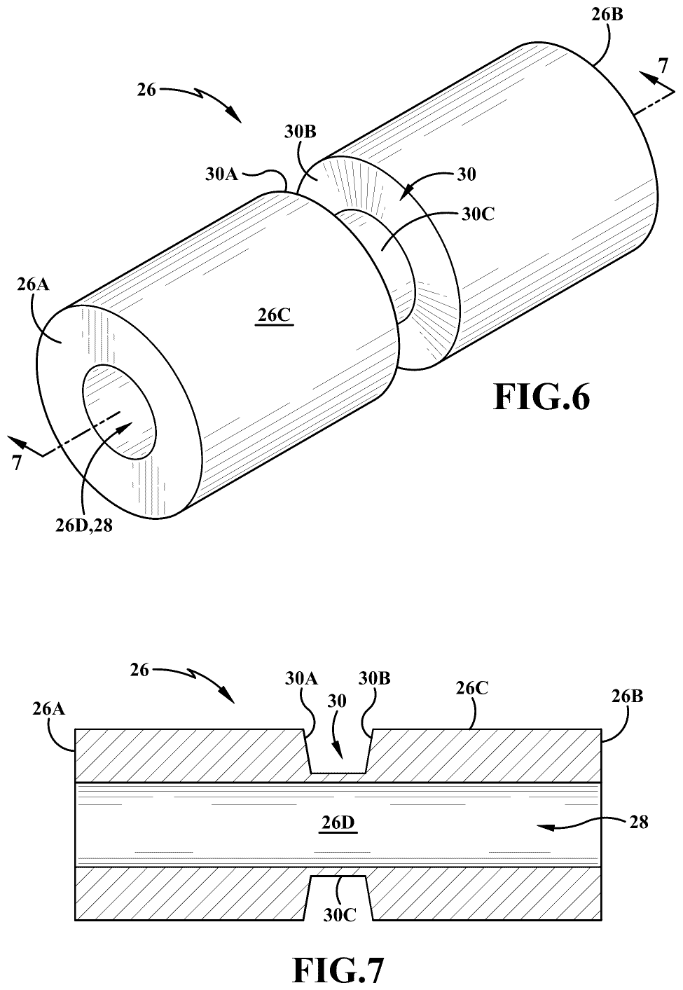

Referring now to FIGS. 6 and 7, there is shown the unfinished barrel 26 with a notch 30 extending inwardly from the outer surface 26C of the unfinished barrel 26. The notch 30 may be formed anywhere along the length of the unfinished barrel 26 at a desired location. The notch 30 is cut into the unfinished barrel 26. The size, shape and location of the notch 30 is determined by the size, shape and location of passageways needs in the final product, i.e., the barrel 10.

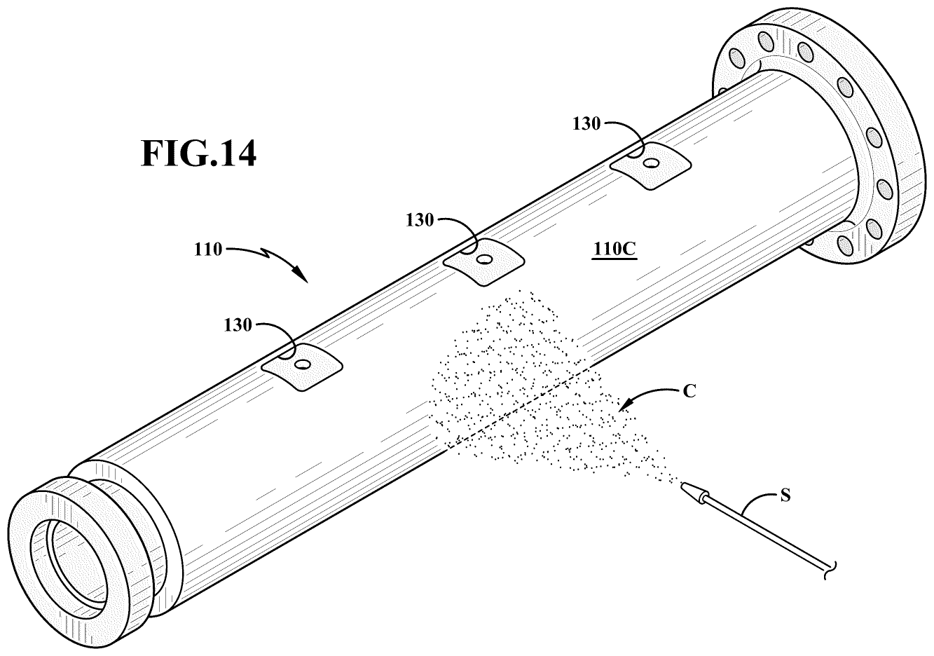

Although pictured herein as the notch 30 extends around the circumference of the unfinished barrel 26, it will be understood that in alternative embodiments the notch 30 may be cut out of only a portion of the unfinished barrel 26 as is shown in FIG. 14.

The notch 30 includes a first side 30A and a second side 30B opposite one another. The notch 30 further includes an end 30C defining the radially innermost point of the notch 30. Such first side 30A, second side 30B, and end 30C are substantially similar to first side 14A, second side 14B, and end 14C of notch 14 discussed above in a completed barrel (such as barrel 10).

As best seen in FIG. 7, the notch 30 does not extend through the unfinished barrel 26, such that the end 30C of the notch 30 and the inner surface 26D of the unfinished barrel 26 are spaced a distance apart from one another. Stated differently, the end 30C of the notch 30 and the inner surface 26D of the unfinished barrel 26 are free from being in communication with one another in this embodiment. Additionally, the notch 30 does not extend into passageway 28 defined by the unfinished barrel 26.

It will be understood that notch 30 may be of any desired shape or size. It will also be understood that unfinished barrel 26 may include any number of notches 30 depending on the size, shape, and configuration of the barrel and/or as dictated by the implementation of said barrel.

It will also be understood that in alternative embodiments, the unfinished barrel 26 may be a rod and then the notch 30 will be of a size and a shape that will allow the user to bore the borehole 12 of the barrel 10 into the rod unfinished barrel 26 and have the end 30C of the notch 30 aligned with the borehole 12 of the barrel 10.

After the notch 30 has been cut into the barrel 26, the notch 30 is filled with a corrosive resistant material 32. The notch 30 is filled with corrosive resistant material 32 by placing the corrosive resistant material 32 atop the end 30C of the notch 30 and utilizing an additive manufacturing process, such as welding or a similar technique or process, to secure the corrosive resistant material 32 to the unfinished barrel 26 at the notch 30.

In one example, the corrosive resistant material 32 is typically high nickel content. It will be understood that corrosive resistant material 32 may be any suitable material, such as Inconel 625, Nicklel, alloys, Nicklel Superalloys, such as Inconel 625, Hastelloy C22, and Hastelloy G-30 to name a few. It will also be understood that corrosive resistant material 32 may be in any appropriate form such as a high-velocity oxygen fuel (HVOF) spray coating, a High-velocity air fuel (HVAF) coating, plasma coating, wire, powder and/or ceramic coatings. In one specific embodiment, the corrosive resistant material 32 is an Inconel wire.

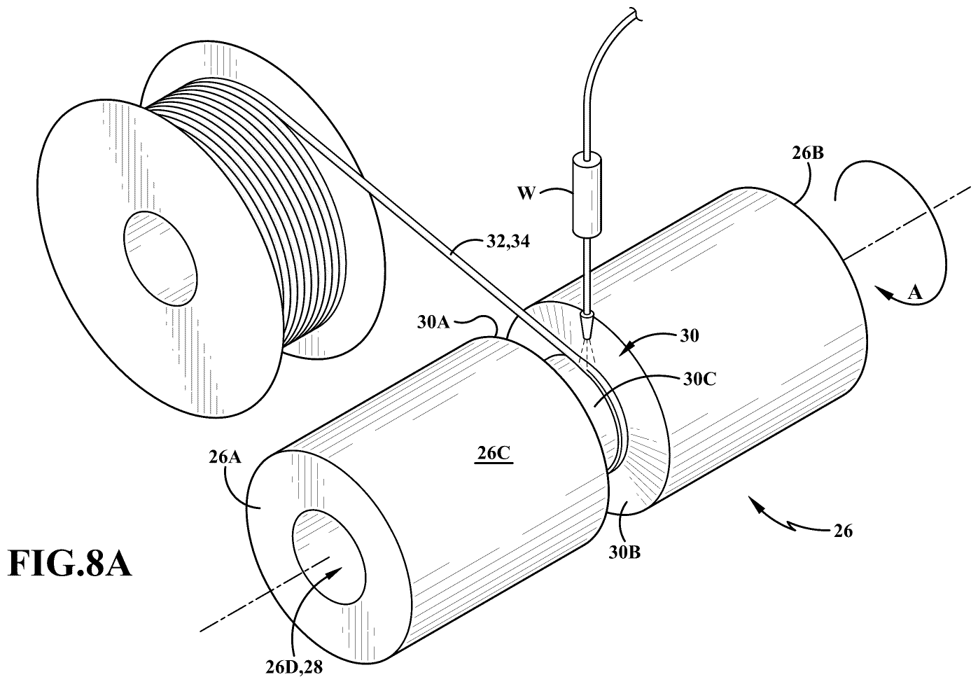

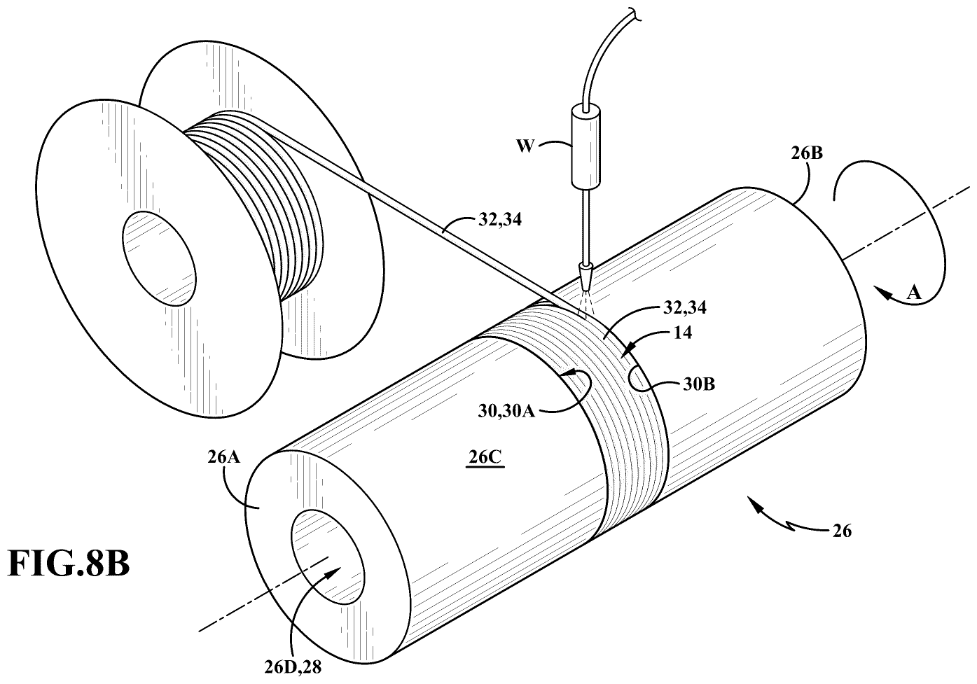

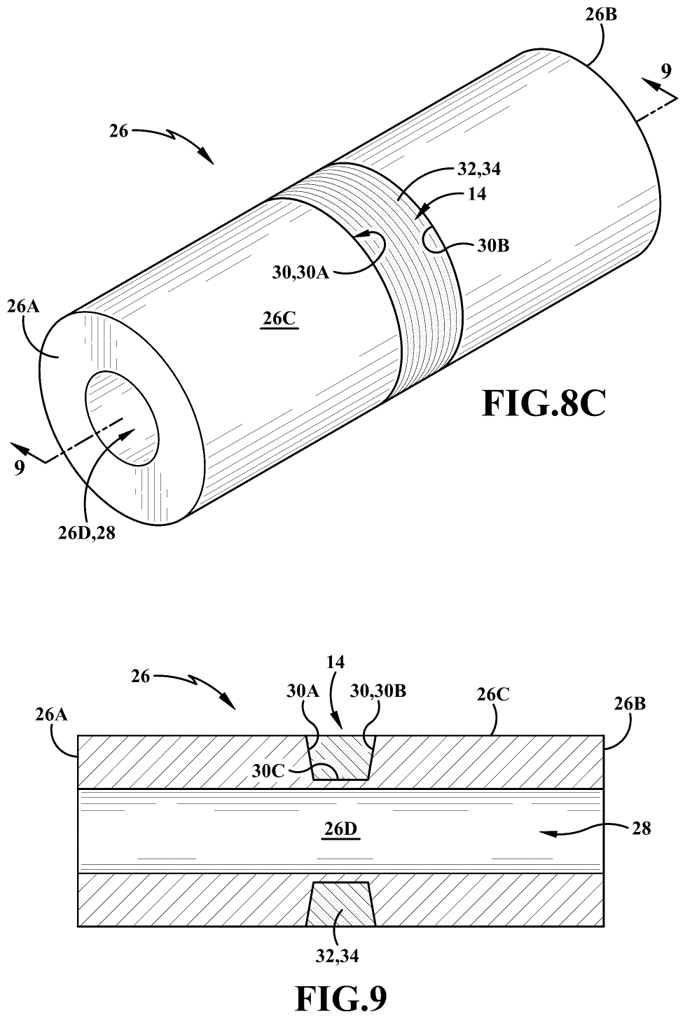

In the specific embodiment shown in FIGS. 8A-8C, the corrosive resistant material 32, which fills the notch 30, is a corrosive resistant wire 34. Referring now to FIGS. 8A, the corrosive resistant wire 34 is placed atop the end 30C of the notch 30 and a laser welder “W” is activated to secure the corrosive resistant wire 34 to the unfinished barrel 26 at the notch 30. As the corrosive resistant wire 34 is secured to the unfinished barrel 26 at the notch 30, the unfinished barrel 26 may be rotated along arrow “A” to secure the corrosive resistant wire 34 around the circumference of the unfinished barrel 26 at the notch 30.

It will be understood that that in alternative embodiments, the corrosive resistant material 32 may secured to the barrel 26 at the notch 30 by other means such as plasma transferred arc (PTA) welding or wire arc additive manufacturing.

It will be understood that alternatively, such as in FIG. 14, the notch 30 is only defined in a portion of the unfinished barrel 26 and therefore the corrosive resistant wire 34 may be pooled into the notch 30 and secured thereto using the laser welder “W”.

Referring now to FIGS. 8B-9, the corrosive resistant wire 34 is continually secured to the unfinished barrel 26 via the laser welder “W” until the corrosive resistant wire 34 is substantially aligned with the outer surface 26C of the unfinished barrel 26.

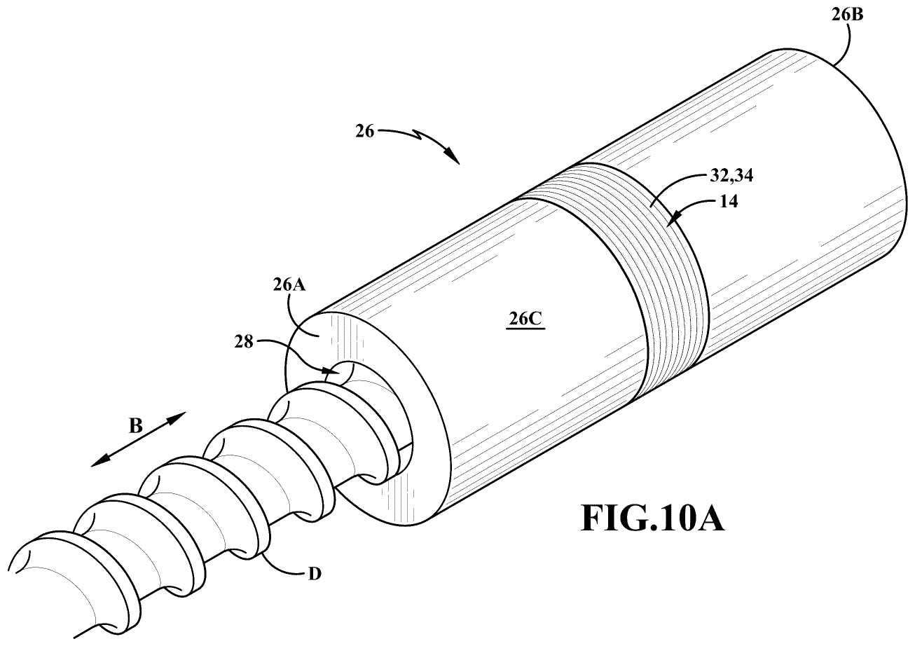

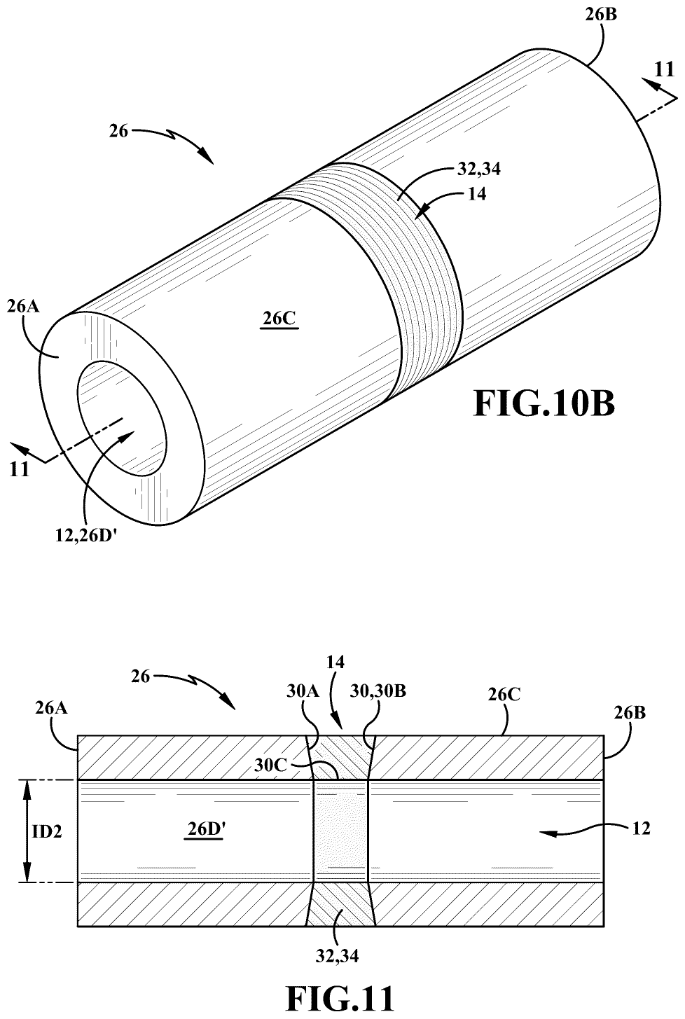

Referring now to FIG. 10A, the passageway 28 of unfinished barrel 26 is further bored by inserting a drill “D” or other similar equipment into the passageway 28 along the arrow “B” to remove material from the passageway 28 of unfinished barrel 26. With such removal of material, a second inner surface 26D′ is thereby formed which is what will be the inner surface 10D of the barrel 10 after unfinished barrel 10 is fully processed.

Referring now to FIGS. 10B and 11, the drill “D” (as seen in FIG. 10A) has been removed and the unfinished barrel 26 now defines the borehole 12 extending through unfinished barrel 26 from first end 26A to second end 26B. The borehole 12 defines an inner diameter “ID2”, which is larger than inner diameter “ID1”. As is best seen in FIG. 11, the second inner surface 26D′ of the unfinished barrel 26 is now substantially aligned with the end 30C of the notch 30 while the second inner surface 26D′ and the notch 30 are still free from being in communication with one another. The second inner surface 26D′ of the unfinished barrel 26 positioned at the notch 30 is now sealed with the corrosive resistant wire 34. The corrosive resistant wire 34 will provide structural support to the unfinished barrel 26 along the longitudinal direction of said unfinished barrel 26.

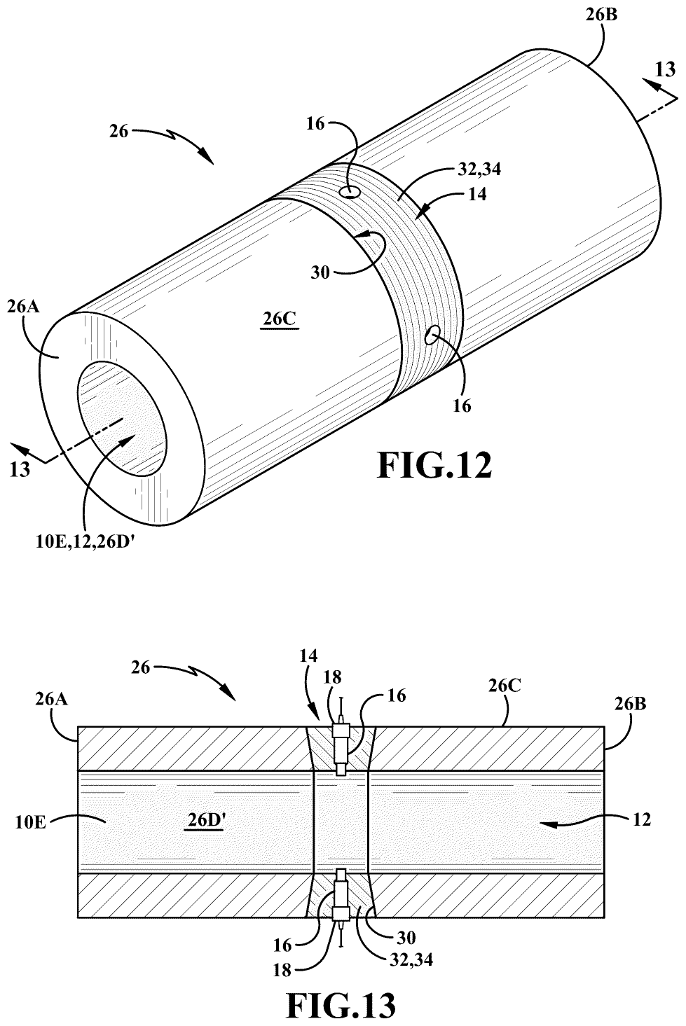

Referring now to FIGS. 12 and 13, the unfinished barrel 26 is now ready to be processed as a standard barrel to become barrel 10, as discussed above, by utilizing current and conventional manufacturing steps. The outer surface 26C of the unfinished barrel 26 may be stripped to ensure a smooth and consistent outer diameter to ensure concentricity of an outer diameter and an inner diameter of the unfinished barrel 26 along the entire length of the unfinished barrel 26. the In FIGS. 12 and 13, the corrosive resistant inlay 10E is now placed along the second inner surface 26D′ of the unfinished barrel 26 so to fully seal the borehole 12 of the unfinished barrel 26 with corrosive resistant material.

Still referring to FIGS. 12 and 13, the unfinished barrel 26 has further been processed by drilling the plurality of passages 16 extending through the unfinished barrel 26 at the notch 30 to place the device 18 (FIG. 13) in each of the plurality of passages 16. Particularly, the plurality of passages 16 is drilled through the corrosive resistant wire 34 in which each passage of the plurality of passages 16 are positioned inside of notch 30. As best seen in FIG. 13, the notch and buildup of corrosive resistant wire 34 seals the entire unfinished barrel 26 from the outer surface 26C to the inner surface 26D with the corrosive resistant wire 34 at the notch 30 to prevent corrosion from the corrosive materials which are used within the unfinished barrel 26 or barrel 10.

It will be understood that the outer surfaces 100, 26C of barrel 10 or unfinished barrel 26 may be made corrosion resistant by spraying or applying the corrosive resistant coating “C” to the outer surfaces 10C, 26C. In one specific embodiment, the corrosive resistant coating “C” is the high-velocity oxygen fuel (HVOF) coating or the high-velocity air fuel (HVAF) coating. It will be understood that the outer layer 22 is made of a ceramic that is painted or wiped on

Referring now to FIG. 14, a barrel 110 is shown which is identical to barrel 10 except for at least one notch 130 that does not extend around the circumference of the barrel 110 and is cut out of only a portion of the barrel 110. Further in FIG. 14, a sprayer “S” is shown applying a corrosive resistant coating “C” in the form of a spray to an outer surface 110C of barrel 110. It will be understood that the sprayer “S” may be used to apply the corrosive resistant coating “C” to any other barrels such as barrel 10 and unfinished barrel 26.

In one specific embodiment, the corrosive resistant coating “C” is a high-velocity oxygen fuel (HVOF) coating or a high-velocity air fuel (HVAF) coating. It will be understood that the corrosive resistant material 32 may be a ceramic that is painted or wiped on.

Having now described barrel 10 and process of producing barrel 10, a method 200 of producing barrel 10 will be discussed herein.

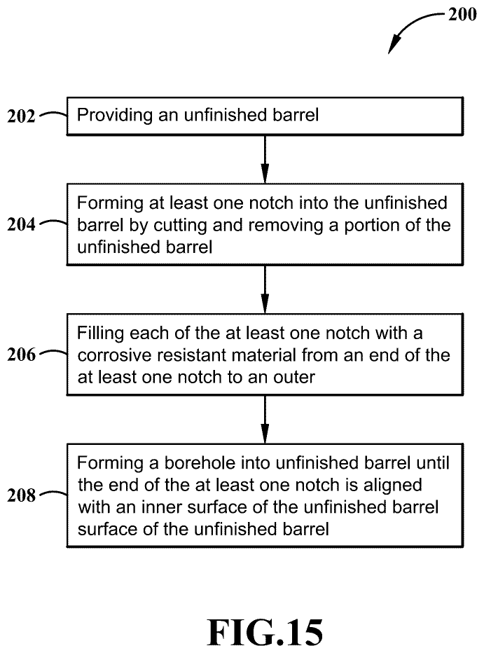

Referring now to FIG. 15, barrel 10 is formed by providing the unfinished barrel 26 (step 202). The unfinished barrel 26 may be made of steel or other similar materials. It will also be understood that unfinished barrel 26 may be a rod. The at least one notch 30 is formed by cutting and removing a portion of the unfinished barrel 26 (step 204). The at least one notch 30 is filled with the corrosive resistant material 32 from the end 30C of the at least one notch 30 to the outer surface 26C of the unfinished barrel 26 (step 206). The passageway 28 of the unfinished barrel 26 is then bored until the end 30C of the at least to one notch 30 is aligned with the inner surface 26C of the unfinished barrel 26 to form the borehole 12 (step 208).

In step 208, the at least one notch 30 is filled with the corrosive resistant material 32 includes securing the corrosive resistant material 32 to the end 30C of the at least one notch 30, where the corrosive resistant material 32 is a corrosive resistant wire 34. In step 208, the step of filling the at least one notch 30 with the corrosive resistant material 32 further includes simultaneously engaging and securing the corrosive resistant material 32 to itself until the corrosive resistant material 32 is aligned with the outer surface 26D of the unfinished barrel 26.

In other exemplary embodiments, method 200 may include optional or further steps of forming a barrel with a corrosive resistant material. In one exemplary embodiment, the method 200 further includes securing the corrosive resistant inlay 36 to the inner surface 26D of the unfinished barrel 26.

In one exemplary embodiment, the method 200 further includes forming at least one passage 16 into the corrosive resistant material 32 inside of the at least one notch 30 and inserting a device 18 into the at least one passage 16.

In one exemplary embodiment, the method 200 further includes applying the corrosive resistant coating “C” or the corrosive resistant material 32 to the outer surface 26C of the unfished barrel 26.

In one exemplary embodiment, the method 200 further includes where the corrosive resistant coating “C” or the corrosive resistant material 32 is a high-velocity oxygen fuel (HVOF) coating or a high-velocity air fuel (HVAF) coating. It will be understood that the corrosive resistant material 32 may be a ceramic that is painted or wiped on.

In one exemplary embodiment, the method 200 further includes engaging the discharge end 20 with the first end 26A of the unfinished barrel 26 and engaging the flange 24 with the second end 26B of the unfinished barrel 26.

In one exemplary embodiment, the method 200 may includes before the discharge end 20 and flange 24 are engaged with the first end 26A and second end 26B of the unfinished barrel 26 respectively, the outer layer 22 of the discharge end 20 and the outer layer (not shown) of the flange 24 are applied to the discharge end 20 and flange 24. The outer layers 22 are made of the corrosive resistant material 32.

In one exemplary embodiment, the method 200 further includes where the outer layers 22 are applied by building the outer layers 22 with corrosive resistant material 32 via welding with a welder such as laser welded “W” (FIG. 8A).

In one exemplary embodiment, the method 200 further includes where the outer layers 22 are applied by spraying the discharge end 20 and the flange 24 with a corrosive resistant coating “C” or the corrosive resistant material 32.

In one exemplary embodiment, the method 200 further includes defining a length along the unfinished barrel 26 and determining a desired located along the length of the unfinished barrel 26. The at least one notch 30 is formed at the desired location. The at least one passage 16 is formed into the corrosive resistant material 32 inside of the at least one notch 30. The device 18 is inserted into the at least one passage 16.

The device, assembly, or system of the present disclosure may additionally include one or more sensors to sense or gather data pertaining to the surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; local pressure changes, submersion in liquid; impellers measuring the amount of fluid passing thereby; global positioning sensors sensing location, elevation, distance traveled, velocity/speed; TV/IR sensors sensing light wavelength; temperature sensors sensing melt temperature, machine temperature, and environmental temperature; lidar sensors; ultrasonic sensors; magnetic sensors, image sensors; and moisture sensors sensing surrounding moisture levels.

If sensors are utilized to gather data relating to the device, assembly, or system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the device, assembly, or system of the present disclosure. In one embodiment, the device, assembly, or system of the present disclosure can be used to teach a sensor model to predict sensor data for a specific scenario. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The device, assembly, or system of the present disclosure may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the device, assembly, or system of the present disclosure. In one example, the autonomous hardware, software, and/or firmware can be installed in and used to control the device, assembly, or system of the present disclosure through the environment based on the sensor data, one or more machine learning models (e.g., neural networks), and the like. A training system may use the training data to train the sensor model to predict virtual sensor data for a given scene, environment, or operation of a component.

The training system can include one or more servers (e.g., a graphics processing unit server) and data stores and may use a cloud-based deep learning infrastructure with artificial intelligence to analyze the sensor data received from the device, assembly, or system of the present disclosure and/or stored in the data store. The training system can also incorporate or train up-to-date, real-time neural networks (and/or other machine learning models) for one or more sensor models.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the device, assembly, or system of the present disclosure may also be sent to a work tracking system that allows the individual, or the organization for which he or she works, to track the status of the various alerts that are received, to schedule particular workers to repair a particular device, assembly, or system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the barrel being cylindrical, the barrel 10 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, although the device, assembly, or system of the present disclosure is described as a complete unit within the present disclosure, it is to be understood that some of the components or features detailed herein can be supplied as a retrofit kit. This approach enables the provision of only certain parts necessary to upgrade a legacy device to the specifications of device, assembly, or system of the present disclosure. Essentially, instead of requiring the replacement of the entire device, the retrofit kit allows for the selective enhancement of specific components. This could allow a user or operator to efficiently upgrade its/their existing legacy devices, systems, or assemblies to achieve the performance and functionality of the device, assembly, or system of the present disclosure without a full replacement. In the event that a component or portion of the device, assembly, or system of the present disclosure is provided as part of a retrofit kit, those components may be integrated into legacy devices, systems or assemblies to upgrade the same. By facilitating partial upgrades, it addresses the need for continuous improvement and adaptation in dynamic environments where complete replacement might be neither feasible nor necessary. As a result, a user or operator would be able to make an enhancement, thereby extending the lifecycle, optimizing, or improving those legacy devices, systems, or assemblies.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

More particularly, the device, assembly, or system of the present disclosure, which may include the logic(s) presented herein, includes the features, components, techniques or processes detailed herein that, as combined, accomplished the desired results detailed herein. These specific elements, configuration or techniques of the device, assembly, or system of the present disclosure, some of which may be included in at least one of the appended claims, accomplish these desired results to overcome the then existing problems in the relevant field of computer processor-based systems. Additionally, the features, components, techniques or processes of the device, assembly, or system of the present disclosure, are an unconventional arrangement of elements or unconventionally perform a method detailed herein that was unavailable without the unconventional arrangement of elements. These exemplary, yet particular, arrangements provide an improvement over existing technologies that have failed to operate in the manner, and with the efficiency that is taught by the device, assembly, or system of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A barrel with a corrosive resistant material comprising:
a first end;
a second end spaced a distance apart from the first end;
an outer surface;
an inner surface spaced a distance apart from the outer surface;
wherein the outer surface and the inner surface extend between the first end and the second end;
at least one notch extending from the outer surface to the inner surface;
wherein the at least one notch is filled with the corrosion resistant material from a base end of the notch and the outer surface; and
a passage extending through the corrosion resistant material inside of the at least one notch.

2. The barrel according to claim 1, further comprising:
a flange adjacent to at least one end of the barrel.

3. The barrel according to claim 2, further comprising:
a discharge end adjacent to an end of the barrel.

4. The barrel according to claim 3, wherein the discharge end and the flange each include an outer layer being made of the corrosion resistant material.

5. The barrel according to claim 3, wherein the discharge end and the flange are made entirely of a corrosive resistant material.

6. The barrel according to claim 4, wherein the corrosive resistant material of each outer layer is made of a high-velocity oxygen fuel coating.

7. The barrel according to claim 1, further comprising:
a corrosion resistant inlay covering the inner surface.

8. The barrel according to claim 7, wherein the corrosion resistant inlay defines a borehole extending from the first end to the second end of the barrel.

9. The barrel according to claim 1, wherein the corrosive resistant material used to fill the at least one notch is corrosive resistant wire.

10. The barrel according to claim 1, wherein the corrosive resistant material used to fill the at least one notch is corrosive resistant powder.

11. A method of forming a barrel with a corrosive resistant material comprising:
providing an unfinished barrel;
forming at least one notch into the unfinished barrel by cutting and removing a portion of the unfinished barrel;
filing each of the at least one notch with a corrosive resistant material from an end of the at least one notch to an outer surface of the unfinished barrel; and
forming a borehole into unfinished barrel until the end of the at least one notch is aligned with an inner surface of the unfinished barrel.

12. The method according to claim 10, wherein filing each of the at least one notch with the corrosive resistant material comprises:
securing the corrosive resistant material to the end of the at least one notch, wherein the corrosive resistant material is a corrosive resistant wire; and
simultaneously engaging and securing the corrosive resistant wire to itself until the corrosive resistant wire is aligned with the outer surface of the unfinished barrel.

13. The method according to claim 12, further comprising:
securing a corrosive resistant inlay to the inner surface of the unfinished barrel.

14. The method according to claim 13, further comprising:
forming at least one passage into the corrosive resistant material inside of the at least one notch; and
inserting a device into the at least one passage.

15. The method according to claim 14, further comprising:
applying a corrosive resistant coating to the outer surface of the unfinished barrel.

16. The method according to claim 15, wherein the corrosive resistant coating is a high-velocity oxygen fuel (HVOF) coating or a high-velocity air fuel (HVAF) coating.

17. The method according to claim 10, further comprising:
engaging a flange with at least one end of the unfinished barrel.

18. The method according to claim 17, further comprising:
engaging a discharge end with an end of the unfinished barrel.

19. The method according to claim 18, proceeded by:
applying an outer layer to the discharge end, wherein the outer layer is made of the corrosive resistant material; and
applying an outer layer to the flange, wherein the outer layer is made of the corrosive resistant material.

20. The method according to claim 19, wherein applying the outer layers to the discharge end and the flange further comprises:
building the outer layer with corrosive resistant material via welding.

21. The method according to claim 18, wherein applying the outer layers to the discharge end and the flange comprises:
spraying the discharge end and the flange with the corrosive resistant material.

22. The method according to claim 11, further comprising:
defining a length along the unfinished barrel;
determining a desired location along the length of the unfinished barrel;
forming the at least one notch at the desired location;
forming at least one passage into the corrosive resistant material inside of the at least one notch; and
inserting a device into the at least one passage.
